(19) United States
(12) Patent Application Publication
(10) Pub. No.: US 2023/0256385 A1
(43) Pub. Date: Aug. 17, 2023

(54) SYSTEM, APPARATUS, AND METHOD FOR EXTRACTING WATER FROM AIR

(71) Applicant: Mahdi Khademi, Playa del Rey, CA (US)

(72) Inventor: Mahdi Khademi, Playa del Rey, CA (US)

(21) Appl. No.: 17/672,452

(22) Filed: Feb. 15, 2022

(51) Int. Cl. B01D 53/26

(52) U.S. Cl. CPC B01D 53/265; B01D 53/266; B01D 2257/80

(57) ABSTRACT

A system, apparatus, and method are provided for extracting water from ambient air. An inlet is provided to receive ambient air into the system, a cooling chamber where extraction of water occurs, and a reservoir for collecting extracted water. The apparatus extracts water by pre-cooling ambient air and then further reducing the temperature of the air in the cooling chamber until water particles condense on surfaces in the cooling chamber. The extracted water is then transferred to the reservoir where it can be collected until a distribution module removes the water from the system. The system may further comprise means for sanitizing the collected water, rendering it safe for human use along with a controlling module and insulated and conductive components configured to reduce energy loss, optimize water recovery, and increase water yield.

### CROSS-REFERENCE TO RELATED APPLICATIONS

Pursuant to 35 U.S.C. § 120, this non-provisional patent application relies on the benefit of U.S. Patent Application Ser. No. 63/248,148, filed Sep. 24, 2021. The content of said application is incorporated herein by reference in its entirety.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to water extraction, and more particularly, to a system, apparatus, and method for extracting and sanitizing water from ambient air to make it safe for human consumption.

### BACKGROUND

Drought and other severe environmental conditions have contributed to a global water crisis that affects water availability for human use, including drinking. Of course, potable water is necessary for survival, but water scarcity negatively impacts 40% of the world's population. Unfortunately, current proposals for providing access to water are deficient because they further aggravate the global water crisis and fail to provide long-term, renewable access to safe water despite environmental conditions.

One proposal for providing access to water is through a public water supply network, which distributes water from a water storage facility through a network to the customer. Although practical in urban areas due to customer proximity, the distribution network is deficient in rural areas because of costs and environmental impact.

Rural customers often have significant distance between themselves and other customers, creating a need for a significant and expensive network. Further, either the pipes are laid underground, disrupting local agriculture, or on the ground, introducing foreign entities and disrupting plant and animal life. Thus, while public water supply networks are practical in urban areas, rural areas have diminished practicality because of costs and environmental impact.

A proposal for providing access to water in rural regions is through wells. However, this proposal is deficient because it is unattainable to many with high upfront costs and a 20% failure rate. Even if a well initially succeeds, the expensive maintenance has caused 60% of wells to fail. Further, a well can adversely affect the local environment by disrupting wildlife and vegetation and introducing harmful chemicals, such as arsenic, into the water supply.

Another proposal for providing access to water is through water bottles. This proposal is deficient because water bottles create significant plastic trash and carbon dioxide emissions. Thus, water bottles have a long-term environmental impact that aggravates the climate crisis. Further, this proposal is deficient because it fails to provide a renewable water supply. Water bottles are limited to the amount supplied, as they require significant manufacturing. Thus, access is limited to the available supply, cannot be renewed, and worsens the current climate crisis.

One proposal suggests extracting water from the air, U.S. Pat. No. 8,641,806 to Claridge to create cool air. However, this proposal is deficient in increasing access to water because the system rejects the water as waste. Thus, this example does not provide a solution for access to potable water.

U.S. Pat. No. 8,747,530, to Goelet, proposes extracting water from the air by placing an absorbent material, such as a sponge, in a container with holes, allowing the air to naturally pass through, and compressing the absorbent material to extract water. However, this system is deficient because it relies on passive collection, thus weather conditions, such as wind and humidity, and the size of the absorbent material limit collection.

Another solution proposed for providing access to potable water is U.S. Pat. No. 8,292,272, to Elsharqawy, which suggests taking liquids, such as seawater, and extracting fresh, potable water through heating. While this proposal shows promise in areas proximate to existing bodies of water, it is not practical in others, such as desert regions, where all forms of water may be hard to come by. Thus, this proposal fails to provide access to potable water in drought conditions.

Currently, no solution proposes actively extracting safe, drinkable water from the air. Thus, although various proposals have been made to solve the problem, none of those in existence combine the characteristics of the present invention. Therefore, there remains a need for a system configured to render water potable on demand, even in areas under drought conditions.

### SUMMARY

The present disclosure is directed to a system, apparatus, and method for extracting and collecting water from ambient air. In general, a plurality of modules comprising the system are operative to extract water from air by receiving the air through at least one inlet, cooling the air by one or more cooling members to create condensation collected on the cooling members, moving the condensation into one or more reservoirs, and distributing collected condensation—or extracted water—for use in irrigation, for drinking, and for other purposes.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In one embodiment, the inlet may be an air duct, hose, or vent in an airflow module. A person of ordinary skill in the art will recognize many other inlets are available and the foregoing are offered by way of example only and not limitation.

In one embodiment, the inlet may be coated to increase efficiency by, for example, reducing heat transfer or friction as air passes through the inlet. In some embodiments, the inlet may comprise a mesh or screen as a filter configured to prevent dust, bugs, and other large particles from entering the system. The air flow module may further comprise a converging diverging nozzle, which may be known to the those of ordinary skill in the art as a de Laval nozzle.

In some embodiments, the air flow module may comprise means for driving ambient air into the system. For example, and without limitation, the means for driving ambient air into the system may be a fan, compressor, or air pressure increase device, such as a booster pump. A person of ordinary skill in the art will recognize that many other means for driving ambient air are available, and, thus, any particular means for driving ambient air into the system shall not limit the invention.

The air flow module may further comprise means for expelling exhaust air after water is extracted. The means for expelling the exhaust air may be passive or active. For example, they air flow module may comprise any of a fan, compressor, or other suitable means as an active mean for expelling exhaust air after water is extracted by the system. In such embodiments, it is contemplated that the air may be expelled from the system via at least one outlet. The outlet may comprise a coating operative to prevent energy loss by, for example, reducing heat transfer or friction when air passes through the outlet. In one embodiment, the outlet may also comprise a filter configured to prevent particles and debris from entering the system.

The system may further comprise a cooling module itself comprising at least one cooling chamber configured to receive ambient air driven through the inlet. The cooling module may comprise at least one cooling member operative to cool air driven into the cooling module. The cooling member may be a conductive surface operative to contact the air such as one or more fins, planes, plates, or another suitably shaped device. The material comprising the conductive surface of the cooling member may comprise metal, ceramic, or a conductive coating. A person of ordinary skill in the art will recognize many other conductive materials are available and the foregoing are offered by way of example only and not limitation.

In some embodiments, the cooling module may further comprise at least one cooling means operative to cool the at least one cooling chamber and, in some embodiments, the cooling member as well. The cooling means may be, for example only and not limitation, a thermoelectric cooler, a water-assisted cooler, effluent air, or coolant, known to those of ordinary skill in the art. It is contemplated that the thermoelectric cooler may utilize thermoelectric, Peltier, or refrigeration style cooling.

The cooling module may further comprise a means for pre-cooling any ambient air as it is driven into the system. The means for pre-cooling may, for example, comprise contacting air entering the system with effluent air to immediately reduce the temperature of the air as it enters the system and before it enters the cooling chamber.

Providing cooling means in the manner described may thus enable extraction of water from air. More particularly, air driven into the system may be cooled upon contacting the air with the cooling member and reducing the temperature of the cooling chamber to dew point temperature, in addition, in some embodiments, to pre-cooling the air. In some embodiments, the water may also or alternatively be extracted from air driven into the system by increasing the pressure in the cooling chamber. It is contemplated that it may be possible for the cooling means may cool the water until ice is formed. The system may comprise a heating means operative to prevent ice formation or melt any ice formed in the cooling chamber. The heating means may be configured to heat any or all of the cooling chamber, cooling means, and/or the entire system. Heating means may even be operative to clean the system. It is further contemplated, that the heating means may heat the entire system. In a further embodiment, the system may be heated for cleaning.

It is contemplated that extracted water may collect on the cooling member or on the surfaces of the cooling chamber.

The system may further comprise a collection module comprise a means for collecting water by way of gravity, centrifugal force, vibration, or some other force, though a person of ordinary skill in the art will recognize many other suitable means for collecting water sufficient to practice the invention.

The collection module may also include at least one reservoir configured to receive and store collected water from the cooling chamber. In some embodiments, the system may further comprise a membrane configured to permit collected water to flow unidirectionally into the reservoir.

The system may further comprise a distribution module including means for distributing extracted water as one or more direct access spouts or taps, though it is also contemplated that pressure operated pumps or valves, tubes, and even those means for water distribution operating on principles of level control and gravity will be sufficient to practice the invention. Thus, it will be recognized that there are many types of means for distributing water from a reservoir available without departing from the invention.

The system may still further comprise a sanitation module having means for purifying extracted water to ensure that water extracted by the system may be potable. As some non-limiting examples, means for purifying extracted water may comprise a filter, ultraviolet light, heat, or chemicals known to purify water. Sanitation will not be strictly required, however, as it is contemplated that extracted water may be diverted for uses that do not require sterilization, such as in irrigation.

In another embodiment, the system may comprise a power module having at least one power supply energized by solar, utility grid, battery, geothermal, hydroelectric, or wind power. The power supply may energize various components of the module, such as the means for driving air into the system, any pumps, elements comprising the sensor and control modules, and other electrically powered components of the system.

It is contemplated that the system will be configured to reduce energy loss where possible. For instance, in some embodiments, elements comprising the system may be insulated. In some embodiments, elements comprising the system or components thereof may comprise conductive paste, coatings, or conductive materials. A person of ordinary skill will recognize innumerable means for reducing energy loss which may be suitable to practice the invention.

In some embodiments, the system may comprise the sensor module having at least one sensor operative to detect moisture, temperature, pressure, stored energy levels, and/or combinations thereof. A moisture sensing detector may be operative to, for example and only and not limitation, detect moisture in ambient air, the water level in the reservoir, and/or the amount of moisture in any air leaving the system. As another example, the sensor for detecting fluid flow may be placed at the outlet or even at the entrance to the reservoir. As still another example, a sensor for detecting air flow may be placed at either or both of the inlet and the outlet. As such, one or more sensors comprising the sensor module may be located next to or in the inlet and/or outlet, in the cooling chamber, or otherwise inside and/or outside the system as needed to operationally sense a condition of interest.

The system may still further comprise a control module operative to receive information from the sensor module. For instance, the control module may receive information characterizing moisture levels from a moisture sensor in the reservoir and, in some embodiments, indicate when the reservoir has reached its capacity and prevent the system from operating further. Likewise, it is contemplated that if the water in the reservoir is diverted or emptied to some volume below its capacity, the control module may be operative to resume water extraction and collection.

The control module may be further operative to assess water quality by way of any of a pH analyzer, conductivity sensors, or turbidity meter. A person of ordinary skill in the art will recognize many other suitable ways to measure water quality, however, and the foregoing are provided by way of example and not limitation.

It is contemplated that the control module may use the data collected by the sensor module for optimization. The control module may, for example, optimize for water yield or energy efficiency. As an example, the control module may optimize water yield by limiting the system's operation to ideal times, such as when ambient temperatures are cooler or when the amount of water to air is relatively high or otherwise detected above some threshold. It is contemplated that operating the system when ambient temperatures are cooler may reduce energy needed to cool air driven into the system since such air may be cooled to the dewpoint by fewer degrees than ambient warmer or hotter air would.

In a further embodiment, the control module may comprise safety monitoring. It is contemplated that the safety monitoring may utilize data collected from the sensor module. For example, safety monitoring may use data from pressure sensors, temperature sensors, and power sensors. It is contemplated that if data is outside of a predetermined threshold, the control module may execute one or more safety steps. In one embodiment, the safety step may be to halt system operation. In another embodiment, the safety step comprises trigging an alarm as, for example, a light, noise, or other suitable method of raising an alarm. In a further embodiment, the safety step may comprise sending a notification to a second device.

Indeed, control module may also be operative to communicate data characterizing energy efficiency, temperature, power levels, usage and troubleshooting across the system to the second device. The second device may be, for example and without limitation, a computer, cellular device, smartphone, tablet, or other computing device operative to receive wired or wireless communications. As such, it may be seen that the control module may operate under user supervision. The control module may, for example, allow the user to control operation of certain modules comprising the system. It is contemplated that the system may be controlled remotely by the second device, by another computing device, or directly by an interface integrated on the system. Still, in some embodiments, the control module may operate autonomously or without user supervision.

In one embodiment, the system may be portable. In such an embodiment, the system may be contained in a carrying case. Modules of the system may in some embodiments be disassembled so that pieces can be stored separately. However, it is contemplated that in some embodiments, the system may be permanently mounted or otherwise installed in some location.

Several advantages of the system, apparatus, and method are that they:

(a) provide access to clean water;

(b) operate independently of municipal water systems;

(c) actively extract water from the ambient air;

(d) increase access to water in water-poor environments;

(e) reduce the strain on natural resources; and

(f) provide increased access to usable water in remote areas.

Thus, it is an object of this invention to provide access to water from a heretofore underutilized source even in extreme drought conditions.

It is yet another object of the invention to independently generate clean water and reduce costs associated with water collection and even purification.

A further object of the invention is to reduce the environmental impact of water collection.

It is an object of this invention to provide access to potable drinking water to remote areas and under emergency circumstances.

It is another object of this invention to provide a system capable of being portable.

It is a further object to reduce costs by allowing interchangeability of modular parts.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows an exemplary embodiment of the interaction between components in the system and apparatus for extracting water from air;

FIG. 2 illustrates a portion of an exemplary embodiment of the system for extracting ambient air as in FIG. 1;

FIG. 3 illustrates an exemplary embodiment of air flow in the system;

FIG. 4 depicts an exemplary embodiment of connection between modules comprising the system for extracting water from air;

FIG. 5 depicts an exemplary embodiment of the interaction between components comprising the system and apparatus for extracting water from air.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically, or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent, or semi-permanent or only for an instant.

The terms “cool air,” “cool dry air,” “dry air,” “exhaust air,” and the like should be broadly understood to relate to air following the extraction of water.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

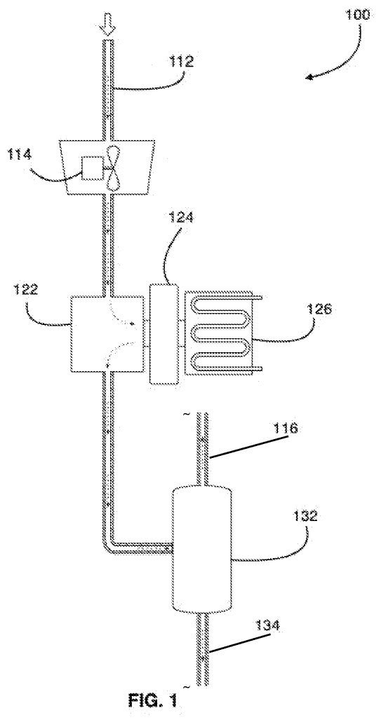

FIG. 1 illustrates an exemplary embodiment of the system for extracting ambient air 100, wherein the embodiment may comprise an inlet 112, a means for driving ambient air into the system as an exemplary fan 114, a cooling chamber 122, cooling member 124, a cooling means 126, and a means for collecting extracted water 132, An outlet for expended air and a reservoir for storing extracted water may be configured off of the means for collecting extracted water 132.

In the embodiment depicted, various elements of the present invention are shown in one of many different possible configurations. It is contemplated that in some embodiments, the physical arrangement or configurations of one or more elements of the present invention may be positioned differently from the arrangement generally disclosed in FIG. 1. Likewise, in some embodiments, the system may comprise multiples of each element or module.

In one embodiment water may be extracted by driving air in through the inlet 112 by the exemplary fan 114 into the cooling chamber 122 where the cooling means 126 may reduce the temperature of the driven air until water may be extracted through condensation. Extracted water as condensation is collected or gathered together in the means for collecting extracted water 132, and diverted to the reservoir, not pictured by path 134. Exhaust comprising dehumidified air may exit the system through an outlet, not pictured, by path 116.

The inlet 112 may be operative to receive ambient air into the system. In some instances, the inlet 112 may comprise at least one filter, preceding the cooling chamber 122, to prevent the entry of dust, bugs, and other particles into certain portions of the system.

The means for driving ambient air is drawn as a fan 114 in the exemplary embodiment, however, it is s contemplated that means for driving air into the system by way of the inlet 112 may alternatively or additionally comprise a fan, compressor, or air pressure increase device. In some embodiments, the means for driving ambient air into the system further comprises a convergent divergent nozzle known to those of ordinary skill in the art.

The cooling means 126 may be operative to cool the chamber 122 in order to cause condensation of water in the air driven into the system. The cooling means 126 may also cool the cooling member 124. The cooling means 126 may be, for example, a thermoelectric cooler, a water-assisted cooler, effluent air, or coolant. In an embodiment where the cooling means 126 is a thermoelectric cooler, the cooling means 126 may, for example, operate on principles of thermoelectric, Peltier, or refrigeration style cooling as known to those of ordinary skill in the art. In instances when the cooling means 126 requires power to operate, the system may further comprise a power supply, not shown, in electrical communication with the cooling means 126.

In instances where effluent air is utilized as a cooling means 126 it may utilize exhaust air. The exhaust air may for example be configured to contact the ambient air entering the system. It is contemplated that the exhaust air may be operative to cool the ambient air through thermodynamic principles. As a clarifying example and without limitation, the exhaust air be operative to pre-cool the ambient air as it enters the cooling chamber.

The exhaust air may leave the system through an outlet located off of path 116 from the means for collecting extracted water 132. Such outlet may comprise any means operative to allow air to pass through. For example, and without limitation, the outlet 116 may be an opening, nozzle, or pipe. It is contemplated that the outlet may further comprise at least one filter configured to prevent particles from entering the system through the outlet. The outlet may be located on any surface of the system. Providing a plurality of outlets throughout the system may beneficially reduce air pressure and energy required to operate the system. However, it is contemplated that manipulating the pressure of air in the system may aid water extraction. In one exemplary embodiment, the outlet may be disposed along ductwork or tubing defining the path 134 the cooling chamber 122 and the reservoir. It is contemplated that the outlet may be configured such that any expelled exhaust air is directed away from the inlet 112. In another embodiment however, the outlet 116 may be configured such that it is located near the inlet 112. Indeed, in some embodiments, it may be possible to recycle air through the system without departing from the invention in order to extract remaining moisture.

The reservoir may be connected to the cooling chamber 122 off of path 134 from the means for collecting extracted water 132 as well. In some embodiments the reservoir 134 may comprise a one-way valve to allow the extracted water to flow into the reservoir 134 but prevent backflow through the means for collecting extracted water 132 and/or into the cooling chamber 122.

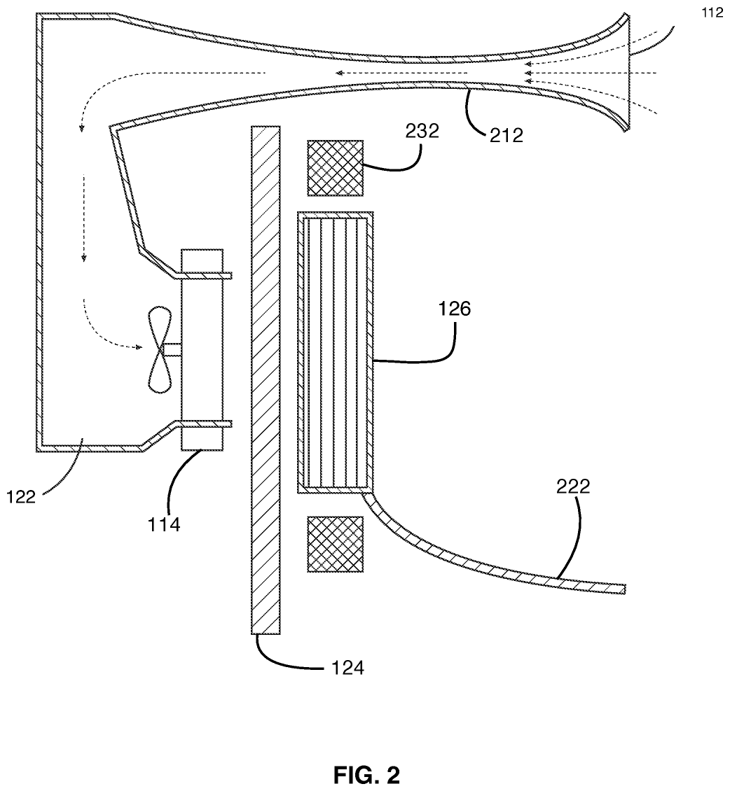

FIG. 2 illustrates one alternative exemplary embodiment of air flow in the system, wherein the embodiment may comprise an inlet 112, a duct 212, exemplary means for driving ambient air as a fan 114, cooling member 124, cooling means 126, insulation 232, and an air separator 222.

In the embodiment shown in FIG. 2 the inlet 112 is depicted as defining converging diverging nozzle configured to reduce air pressure within the system and, as a result of this pressure drop, reduce the temperature of the air as well. This may beneficially reduce energy needed to cool ambient air, however, it is possible that the system may operate without any nozzle, another type of nozzle, and other configurations of the inlet 112.

FIG. 2 further illustrates that the inlet 112 may be connected to the cooling chamber 122 through a duct 212.

FIG. 2 shows one exemplary embodiment comprising insulation 232 at or near the cooling means 126 to reduce energy loss in the system. Insulation may be present at other locations throughout the system. For example, the reservoir may be insulated. As a further example, the air separator 222 may be insulated to reduce heat transfer between relatively cool air passing through the cooling chamber and warm air received into the system. Other means for reducing energy loss may, for example and without limitation, comprise fabricating elements comprising the system out of high conductivity materials and/or coating elements within the system with conductive paste. Indeed, it is contemplated that any components of the system may be configured in this manner to reduce energy loss and even optimize cooling where desired.

In some embodiments, the air separator 222 may be operative to direct exhaust air so it can be utilized as the cooling means 126. The directed exhaust air may, in one embodiment, be operative to perform pre-cooling of the air entering the system. This is accomplished by contacting the ambient air entering the system with the directed exhaust air, thus reducing the temperature of the air as it enters the system. The exhaust air may, for example, be air in which water has previously been extracted by the system. It is contemplated that using the exhaust air as a cooling means 126 it may reduce overall energy consumption. It is further contemplated that using the exhaust air as a cooling means 126 may increase the water yield since recycled air may be subject to cooling and water extraction multiple times.

The air separator 222 may be further operative to direct air out of the system as exhaust through one or more outlets discussed above. In some instances, the air separator 222 may be operative to direct exhaust the one or more outlets following after such air has been recycled through the system for pre-cooling.

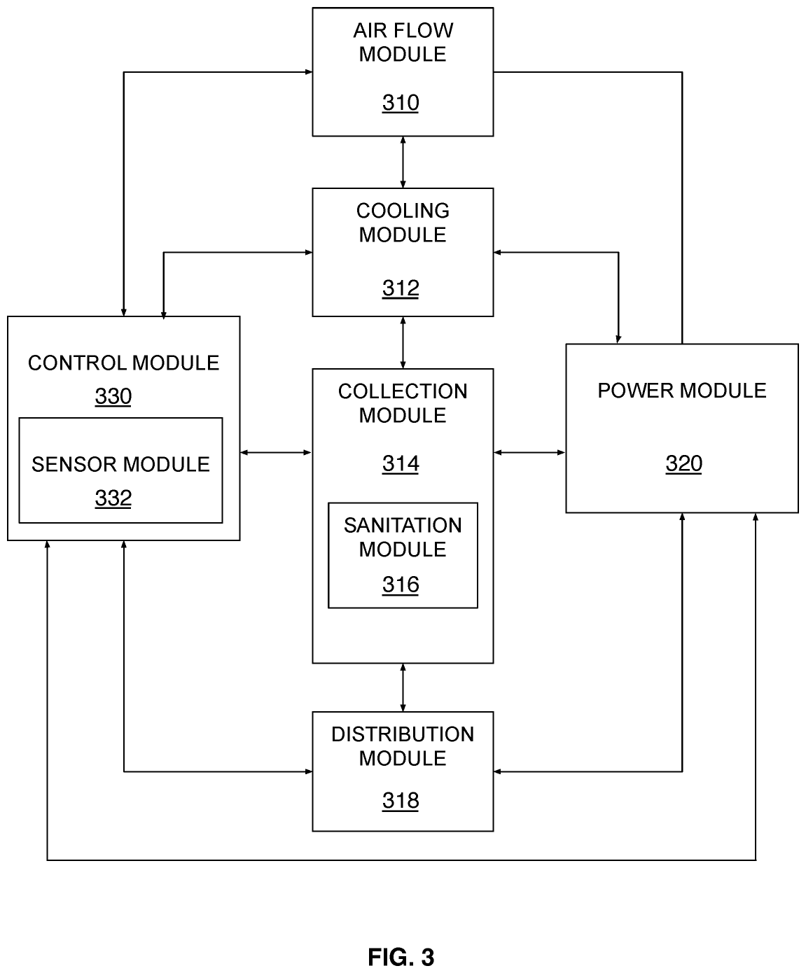

FIG. 3 depicts an exemplary embodiment of connection between a plurality of modules comprising the elements of the system. More particularly, the system may comprise an air flow module 310, a cooling module 312, a collection module 314, a sanitation module 316, a distribution module 318, a control module 330, a sensor module 332, and a power module 320.

The air flow module 310, for instance, may comprise the inlet 112, means for driving ambient air 114, outlet 116, and duct 212 referenced with respect to exemplary embodiments in FIG. 1 and FIG. 2. More particularly, and with continued reference to FIG. 3, the air flow module 310 may be operative to move ambient air into the system and remove exhaust air from the system. It is contemplated that the power module 320 may be connected with the air flow module 310 to provide power to the means for driving ambient air 114.

The cooling module 312 may comprise the cooling chamber 122, cooling member 124, and cooling means 126 shown in FIG. 1. Returning to FIG. 3, The cooling module 312 may be operative to cool the ambient air and extract water from the cooled air as condensation. In some embodiments, the cooling means be connected to the power module 320 as well. As an example, in instances where the cooling means is a thermoelectric cooler, the power module 320 may provide the necessary power to allow for the thermoelectric cooler to operate.

The collection module 314 may comprise one or more reservoirs. In some embodiments, the collection module 314 may further comprise a collection means operative to assist moving water through the system and into the reservoir 134. In some instances, the collection means may comprise a device that may, for example, be operative to collect the extracted water through on principles of gravity, vibration, centrifugal force, and pushing. For instance, the collection means may comprise one or more plates or surfaces tilted downward to cause condensation collected thereon to slide downward, under gravity, into the reservoir. A plate or surface may be in electrical communication with a motor that causes such plate or surface to shake or spin, causing condensation collected thereon to flow into the reservoir. Likewise, a motorized squeegee may be operative to push condensation into the reservoir. Thus, it may be seen that the particular collections means will not limit the invention. In any event, the power module 320 may be connected to the collection means as well.

As shown in FIG. 3, the collection module 314 may further comprise a sanitation module 316 itself comprising means for purifying water. The sanitation module 316 may be operative to purify the extracted water in order to render it potable or otherwise fit for use.

The means for purifying water may for example be one or more filters, an ultraviolet light, heat, or chemicals. In one embodiment, when the means for purifying water is one or more filters, such filters may, for example and without limitation, be located on the entry of the reservoir 134 shown in FIG. 1.

The means for sanitation may also be connected with the power module 320. For example and without limitation, the means for sanitation may be ultraviolet lights that receive power from the power module 320. It is contemplated that in such an example, the ultraviolet lights may be located within reservoir 134 shown in FIG. 1. The methods in which ultraviolet lights may be operated for sanitation are understood by those in the art and are incorporated herein by reference.

Alternatively, or in addition to the foregoing, the sanitation module 316 may comprise a heating source operative to increase the temperature of the extracted water as a means for purification. The heating of water for purification is well understood in the art. It is contemplated that the heating source may be connected to the power module 320.

The sanitation module 316 may alternatively or additionally comprise chemicals as a means for purifying extracted water. As an example, and without limitation, the chemicals may comprise non-toxic levels of chlorine sufficient to disinfect extracted water. However, a person of ordinary skill in the art will understand other chemicals for purifying water and the concentrations used to practice the invention.

In some embodiments, the sanitation module 316 may be located in the distribution module 318 rather than the collection module 314. For example, a filter comprising the sanitation module 316 may be located within the distribution module 318, such that the water is purified as it is leaving the system.

The sanitation module 316 may additionally be an independent module (not shown). For example, the extracted water may enter into the sanitation module that is not within any of the cooling module 312, collection module 314, or distribution module 318.

A distribution module 318 in accordance with one embodiment of the invention may comprise means for distributing the extracted water. As shown in FIG. 3, the distribution module 318 may be connected to the collection module 314. In such an embodiment, the distribution module 318 may be operative to take the extracted water that was collected in the reservoir, and remove the extracted water from the system. The means for distributing the extracted water may, for example and without limitation, be an opening for direct access, pumps, tubes, or valves.

It is contemplated that the distribution module 318 may be configured in a manner operating on principles of gravity. For example, and without limitation, the means for distribution, such as a tube or valve, may be located at or near the bottom of the reservoir. In such an example, gravity may allow for the water to exit the system as it flows downward toward such tube or valve.

In another embodiment, the means for distributing extracted water may be connected to the power module 320. For example, a pump may be connected to the power module 320 and operative to distribute water from the system.

In another embodiment, the means for distributing extracted water may be user operated. For example and without limitation, the means for distributing extracted water may allow the user to open the reservoir and physically remove the extracted water, as desired. As a clarifying example, the distribution module may comprise a coverable opening in the reservoir, that can be accessed and through which water can be transferred to another container outside of the system. In a further clarifying example, system may be configured such that the distribution module 318 comprises the reservoir, and the distribution module is configured to be removable from the system with the extracted water still within the reservoir. In another example, a manual or electric pump may be operated on demand by a user to pump the extracted water out of the system.

As shown in FIG. 3, the control module 330 may comprise the sensor module 332. The sensor module 332 may comprise at least one sensor. It is contemplated that the control module 330 is operative to receive the data collected by the at least one sensor. The control module 330 may be configured to interpret the data and execute changes to the system.

The at least one sensor of the sensor module 332 may be distributed amongst and within other modules comprising the system and further be configured to detect at least one variable selected from, for example only and not limitation, moisture level, system or module temperature, pressure within certain modules, power use as by or among certain modules, and water quality, or combinations thereof.

In one embodiment, the at least one sensor may be located within the air flow module 310. The at least one sensor in the air flow module may, as a non-limiting example, be operative to detect the amount of moisture, or humidity, in ambient and/or exhaust air. As an example, sensors in the air flow module 310 may for example be located on the inlet and outlet to measure the moisture of ambient air and the cool, dry air leaving the system, respectively. In such an example, the control module 330 may be operative to adjust system operations in order to reduce the moisture in the cool dry air and further to increase water yield.

In another example, the at least one sensor may be located within the cooling module 312. For example, the at least one sensor may be operative to detect the temperature in the cooling module 312. As another example, the at least one sensor may be operative to detect the pressure in the cooling chamber. The control module 330 may be operative to adjust cooling member to increase water yield. For example, the control module 330 may reduce the temperature of the cooling member to increase the water yield.

In a further example, the at least one sensor may be located within the collection module 314. As a non-limiting example, the at least one sensor may be located at the entrance of the reservoir to detect how much extracted water is entering the reservoir or moisture levels within the reservoir. Control module 330 may receive the detected moisture level as detected by the exemplary sensor, and be configured to run or halt operation of the system accordingly. If a the sensor detects moisture levels above a predetermined threshold in the reservoir, for example, the control module 330 may be operative to prevent the system from operating until the water level is reduced to some level below such threshold.

In another example, the at least one sensor in the reservoir 134 may be operative to detect temperature.

In an additional embodiment, the sanitation module 316 may comprise at least one sensor. As an example, the at least one sensor may be operative to measure water quality and comprise, without limitation, a pH analyzer, conductivity sensor, and/or turbidity meter. The control module 330 may, for example, be operative to detect water quality and determine whether extracted water is fit for consumption or general use.

In another embodiment, the distribution module 318 may comprise at least one sensor. For example and without limitation, it is contemplated that the at least one sensor in the distribution module 318 may be operative to measure the amount of water leaving the system. In such an example, the control module 330 may be operative to prevent or allow water to leave the system.

The power module 320 may comprise a power supply as, for example and not limitation, a battery or utility grid. In instances when the power supply is a battery, the battery may for example be rechargeable. The battery may be, without limitation, recharged by solar, wind, or the utility grid.

As shown in FIG. 3, the power module 320 may be operative to connect with the control module 330. In such an embodiment, the at least one sensor may be operative to detect power levels, such as a power level stored in the battery. In instances where the sensor determines that the battery is at less than full charge, the control module 330 may be operative to allow the battery to charge. In some embodiments, the control module 330 may receive the temperature of the battery. If, for example, the battery is at an elevated temperature, the control module 330 may prevent the system from operating until the battery temperature has been reduced.

As another non-limiting example, the control module 330 may be operative to receive the temperature from sensors in electrical communication with different components of the system that are operated by the power module. For example, the control module 330 may receive information relating to the temperature of the means for driving ambient air 114 as shown in FIG. 1. If a sensor detects that means for driving ambient air 114 is at some temperature above a predetermined threshold temperature, such as a threshold at which electrical components will experience damage or otherwise fail, the control module 330 may prevent the system from operating until the means for driving ambient air 114 has reduced in temperature to some other level.

In light of the foregoing, it may be recognized that sensor module 332 may comprise at least one type of sensor located in multiple modules. That is, the sensors may, for example and without limitation, be operative to detect the same variable as one another in different modules.

In another example, at least one sensor may be located externally from the system. For example, an at least one external sensor may be located on an exterior surface of the system. or at some distance away from, but in communication with, aspects of the system. In such an example, the control module 330 may be operative to utilize data received from the sensors to improve efficiency. For example, the external sensor may be operative to detect moisture levels, temperature, or air flow. It is contemplated that the control module 330 may be operative to analyze data received from the at least one external sensor to optimize the system for water recovery or to increase energy efficiency. For example, if an external sensor detects low moisture in the ambient air, the control module 330 may be operative to prevent the system from operating for lack of sufficient water available for extraction. As a further example, if an external sensor detects low ambient temperature, the control module 330 may be operative to allow the system to operate. Whereas in instances of high temperature the control module 330 may prevent the system from operating until the outside temperature has been reduced. Thus, it may be seen that the control module, and various sensors, may be configured to automatically execute energy saving operations in response to certain detected conditions.

The control module 330 may be further operative to communicate with a second device. For example, the second device may be a computer, cellular device, tablet, or other devices operative to receive communication. The control module 330 may be operative to communicate over wired or wireless communication. The control module 330 may send information collected from the sensor module 332. It is contemplated, that the control module 330 may receive information relating to desired outcomes, for example, improved water yield.

The control module 330 may also be configured to monitor conditions related to safety. In one exemplary embodiment, the control module 330 may be operative to analyze data received from the sensor module 332 and determine whether the system is operating within pre-determined safe parameters. If the system is operating outside of the pre-determined safe parameters, it is contemplated that the control module 330 may be operative to execute a safety step such as, for example, halting system operation, sending a notification to the second device, executing an alarm, and/or combinations thereof. In some embodiments, the alarm, may be a light, noise, or other suitable method of raising an alarm.

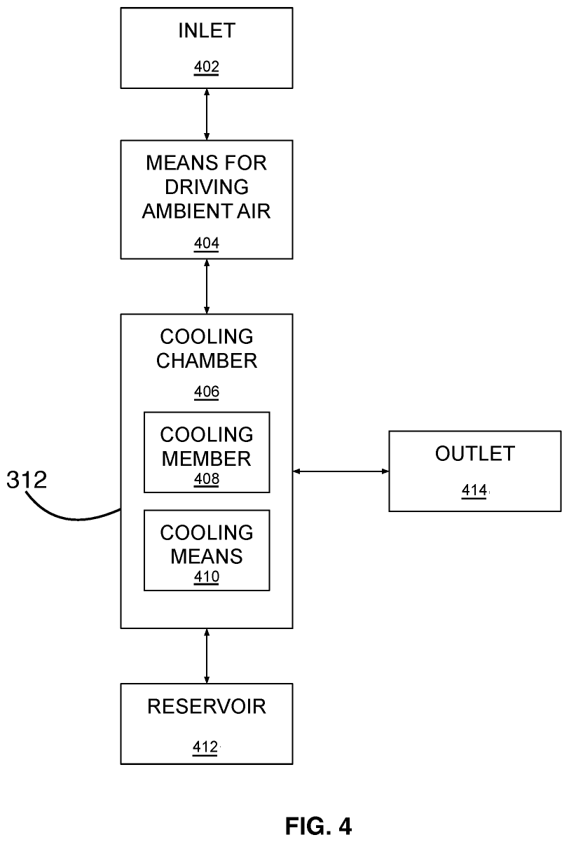

FIG. 4 depicts an exemplary embodiment of the arrangement and interaction between components in the system and apparatus for extraction of water from air. This embodiment may comprise from the airflow module, an inlet 402, means for driving ambient air 404 into the system, and outlet 414; from the cooling module a cooling chamber 406, cooling member 408, and cooling means 410; and, from the collection module, a reservoir 412.

Such exemplary inlet 402 may be connected to the means for driving ambient air 404 such that the ambient air may be taken into the system through to the cooling chamber 406. The cooling chamber 406 may comprise cooling means 410 configured to cool the cooling member 408 and the cooling chamber 406, thus cooling air driven in to the cooling chamber. In this exemplary embodiment, the cooling chamber 406 may then be connected to the reservoir 412 and the outlet 414. It is contemplated that this is only one of many configurations for the outlet 414. For example and without limitation, the outlet 414 may be located in the reservoir 412 or at some point along any means for connecting the reservoir 412 and the cooling chamber 406, such as pipes or ductwork.

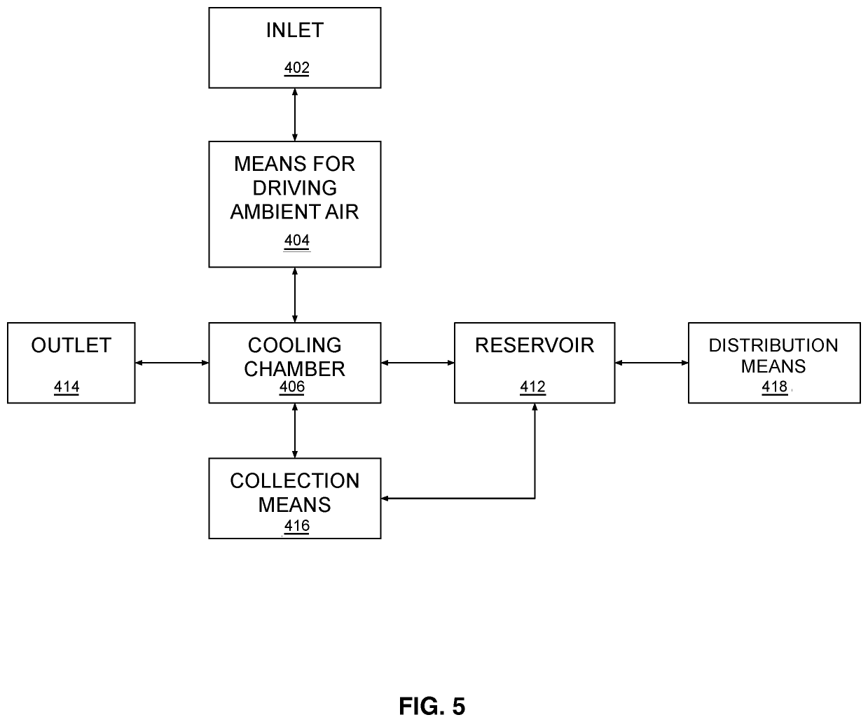

FIG. 5 depicts another exemplary embodiment of the configuration and interaction between components of the system and apparatus for extracting water from air. In this embodiment, exemplary outlet 414 is connected to the cooling chamber 406. It is contemplated that placing an outlet in this manner may ease recycling of air through the system for further water extraction on the basis of proximity to the inlet 402 and/or means for driving ambient air 404. In some embodiments, it is contemplated that providing an outlet for exhaust at the cooling chamber 406 may also, or alternatively, beneficially reduce energy transfer between extracted water and exhaust air. It will also be seen that a collection means 416 and the reservoir 412 may be separate from one another. This may allow users to remove the reservoir, for instance, without disturbing other components or modules comprising the system. Finally, a means for distributing 418 from embodiments of the distribution module described above, may be connected to the reservoir 412 according to any manner described above.

Thus, it may be seen that in the exemplary embodiment of FIG. 5 a direct connection between the cooling chamber 406 and the reservoir 412 exists, and, as such, the reservoir 414 may be configured to receive extracted water directedly from the cooling chamber 406 without the assistance of the collection means 416, though including a collection means 416 may more effectively deliver extracted water into the reservoir 412.

Of course, it will be understood that while FIGS. 4 and 5 depict particular exemplary embodiments of the arrangement and selection of parts comprising the system for extraction of water from air, many other arrangements and connections between parts are possible without departing from the invention.

### CONCLUSIONS, RAMIFICATIONS, AND SCOPE

While certain embodiments of the invention have been illustrated and described, various modifications are contemplated and can be made without departing from the spirit and scope of the invention. For example, the reservoir in the system may be connected to a greater reservoir where water from multiple sources is stored. It is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, apparatus, and method for extracting water from air with which that terminology is associated. In general, the terms used in the following claims should not be constructed to limit the system, apparatus, and method for extracting water from air to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, apparatus, and method for extracting water from air is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, apparatus, and method for extracting water from air.

What is claimed is:

1. A modular system for collecting water from ambient air comprising:
(a) an air flow module comprising an inlet configured to receive air, a means for driving ambient air, and an outlet configured for air to exit the system;
(b) a cooling module comprising a cooling chamber, at least one cooling member configured to contact the air, and additional cooling means;
(c) a collection module comprising a reservoir configured to store the extracted water and a means for transferring extracted water;
(d) a power module; and
(e) a distribution module.

2. The system of claim 1, further comprising a sanitation module configured to purify the water.

3. The system of claim 2, wherein the means for purifying water is selected from the group consisting of ultraviolet light, particle filtration, chemical treatment, heat treatment, and combinations thereof.

4. The system of claim 1, wherein the means for driving ambient air is a device selected from a group consisting of a compressor, a fan, and a booster pump.

5. The system of claim 1, further comprising a control module having at least one sensor.

6. The system of claim 5, wherein the at least one sensor is configured to monitor conditions from a group consisting of temperature, pressure, power, moisture, water quality, and combinations thereof.

7. The system of claim 5, wherein the control module is configured to receive data from at least one sensor, compare the data to a threshold, and if the data is outside of the threshold, execute one or more steps selected from a group consisting of activating an alarm, sending a notification, shutting down the system, cycling through heating and cooling of the system, and combinations thereof.

8. The system of claim 1, wherein the cooling means is selected from a group consisting of a thermoelectric cooler, a fan, effluent air, a coolant, and a thermodynamic refrigeration device.

9. The system of claim 1, further comprising a heating source.

10. The system of claim 1, wherein the system comprises a plurality of inlets, forced air devices, cooling chambers, and outlets.

11. An apparatus for water collection comprising:
(a) an air inlet;
(b) a forced-air device configured to drive air into the system;
(c) a cooling source;
(d) a cooling chamber having at least one cooling member;
(e) a reservoir;
(f) an air outlet; and
(g) a power supply.

12. The apparatus of claim 11, wherein the air inlet comprises a filter.

13. The apparatus of claim 11, wherein the reservoir comprises a purification device selected from the group consisting of filters, ultraviolet lights, chemicals, and combinations thereof.

14. The apparatus of claim 11, further comprising a heating source.

15. The apparatus of claim 11, wherein the cooling source is operative to cool the cooling chamber.

16. The apparatus of claim 15, wherein the cooling source is selected from the group consisting of a thermoelectric cooler, a fan, effluent air, a coolant, and a thermodynamic refrigeration device.

17. The apparatus of claim 11, further comprising a monitoring device wherein the monitoring device is configured to monitor variables from a group consisting of temperature, pressure, power, moisture, water quality, and combinations thereof.

18. The apparatus of claim 11, wherein the forced-air device is selected from a group consisting of a compressor, a fan, and a booster pump.

19. A method for extracting water from air comprising:
(a) receiving ambient air into an apparatus through an inlet;
(b) pre-cooling the ambient air;
(c) moving the pre-cooled air into a cooling chamber having a cooling member;
(d) reducing the temperature of the cooling member;
(e) causing contacting the pre-cooled air in the cooling chamber with the cooling member, extracts water from the air;
(f) collecting extracted water from the cooling member;
(g) transporting extracted water to a reservoir;
(h) purifying extracted water in the reservoir;
(i) expelling the exhaust air from the apparatus; and
(j) monitoring the level of extracted water in the reservoir.
